(19) United States
(12) Patent Application Publication
(10) Pub. No.: US 2018/0174091 A1
(43) Pub. Date: Jun. 21, 2018

(54) OVERLAPPING HOUSEKEEPING ROOM ASSIGNMENTS

(71) Applicant: CleanMeNext LLC, Winter Park, FL (US)

(72) Inventors: Bill John Aspromonte, Winter Park, FL (US); Avram Seth Weiss, New York, NY (US)

(21) Appl. No.: 15/846,775

(22) Filed: Dec. 19, 2017

Related U.S. Application Data
(60) Provisional application No. 62/436,379, filed on Dec. 19, 2016.

(51) Int. Cl. G06Q 10/06

(52) U.S. Cl. CPC G06Q 10/063114; G06Q 50/12; G06Q 10/063118

(57) ABSTRACT

Embodiments of the disclosure provide systems and methods for dynamically adapting task assignments in real-time, or near-real time, based on information received from a remote property management system or at least one or a plurality of mobile devices. Utilizing current room status information a dynamic list of rooms to service can be generated for each housekeeper and provided to each housekeeper through a mobile device. According to one embodiment, rooms can be assigned to multiple housekeepers. Additionally, room status can be update though the mobile devices. When room status information is updated, either by the property management system or through a mobile device, the task assignments can be dynamically updated. The first available housekeeper can then service rooms in a timelier and more efficient manner.

### CROSS REFERENCE TO RELATED APPLICATION

The present application claims the benefits of and priority, under 35 U.S.C. § 119(e), to U.S. Provisional Application No. 62/436,379 filed Dec. 19, 2016 by Aspromonte and entitled “Overlapping Housekeeping Room Assignments” of which the entire disclosure is incorporated herein by reference for all purposes.

### FIELD OF THE DISCLOSURE

Embodiments of the present disclosure relate generally to methods and systems for dynamically assigning tasks to a set of resources and more particularly to dynamically adapting, task assignments in real-time, or near-real time, based on information received from a remote property management system or at least one or a plurality of mobile devices.

### BACKGROUND

Traditionally, each room in a hotel is assigned one housekeeper for service regardless of room availability or need. This method does not allow rooms to be cleaned in the most efficient manner for availability. For example, a housekeeper may spend time waiting or looking for a room to service on an assigned list when a room close by is immediately available but is assigned to another housekeeper. This method also prevents higher priority rooms may be in waiting even though there is an available housekeeper to clean them. Hence, there is a need for improved methods and systems for dynamically adapting task assignments.

### BRIEF SUMMARY

Embodiments of the disclosure provide systems and methods for dynamically adapting task assignments in real-time, or near-real time, based on information received from a remote property management system or at least one or a plurality of mobile devices. Utilizing current room status information, a dynamic list of rooms to service can be generated for each housekeeper and provided to each housekeeper through a mobile device. According to one embodiment, any one room or collection of rooms can be assigned to multiple housekeepers. Additionally, room status can be update though the mobile devices. When room status information is updated, either by the property management system or through a mobile device, the task assignments can be dynamically updated. Rooms can then be serviced in a timelier and more efficient manner by the first available housekeeper.

Embodiments include a method for dynamically assigning tasks, the method comprising: generating, by a resource management system, an initial set of task assignments based on information received from a remote property management system, wherein the initial set of task assignments comprise assignment of a plurality of workforce resources to each of one or more sections of a property, each section comprising a plurality of sub-units and wherein the assignment of the workforce resources comprises overlapping assignment of two or more of the workforce resources to at least one or the one or more sections of the property; providing, by the resource management system, the generated initial set of task assignments to each of a plurality of mobile devices, each mobile device associated with one of the workforce resources of the plurality of workforce resources; dynamically adapting, by the resource management system, the initial task assignments in real-time based on information received from the remote property management system or at least one or the plurality of mobile devices; and providing, by the resource management system, an indication of the dynamically updated task assignments to the remote property management system and at least one or the plurality of mobile devices.

Aspects of the above method include wherein generating the initial set of task assignments based on the information received from the remote property management systems comprises: assigning, by the resource management system, the sub-units of one or more sections to the initial set of task assignments for each of the workforce resources.

Aspects of the above method include wherein generating the initial set of task assignments based on the information received from the one or more of a plurality of property management systems further comprises: receiving, by the resource management system from the remote property management system, an indication of an initial status for each of the sub-units of each section; and providing, by the resource management system, an indication of the initial status for each sub-unit in the initial set of task assignments.

Aspects of the above method include wherein dynamically adapting the initial task assignments in real-time further comprises: receiving, by the resource management system from a first mobile device of the plurality of mobile devices an updated status for a sub-unit of one or the sections; and providing, by the resource management system, an indication of the updated status for the sub-unit of the one or more sections to the remote property management system and at least one second mobile device of the plurality of mobile device.

Aspects of the above method include wherein providing the indication of the updated status for the sub-unit of the one or more sections to the at least one second mobile device further comprises generating an updated set of task assignments for the workforce resource associated with each of the at least one second mobile device based on the received updated status.

Aspects of the above method include wherein the updated set of task assignments removes a task from the initial set of task assignments, changes a priority of task assignments in the initial set of task assignments, or indicates that a task assignment in the initial set of task assignments is now ready to be handled.

Aspects of the above method include wherein dynamically adapting the initial task assignments in real-time further comprises: receiving, by the resource management system from the remote property management system an updated status for a sub-unit of one or the sections; and providing, by the resource management system, an indication of the updated status for the sub-unit of the one or more sections to at least one device of the plurality of mobile device.

Aspects of the above method include wherein providing the indication of the updated status for the sub-unit of the one or more sections to the at least one mobile device further comprises generating an updated set of task assignments for the workforce resource associated with each of the at least one mobile device based on the received updated status.

Aspects of the above method include wherein the updated set of task assignments removes a task from the initial set of task assignments, changes a priority of task assignments in the initial set of task assignments, or indicates that a task assignment in the initial set of task assignments is now ready to be handled.

Embodiments include a system comprising: a processor; and a memory coupled with and readable by the processor and storing therein a set of instructions which, when executed by the processor, causes the processor to dynamically assign tasks by: generating an initial set of task assignments based on information received from a remote property management system, wherein the initial set of task assignments comprise assignment of a plurality of workforce resources to each of one or more sections of a property, each section comprising a plurality of sub-units and wherein the assignment of the workforce resources comprises overlapping assignment of two or more of the workforce resources to at least one or the one or more sections of the property; providing the generated initial set of task assignments to each of a plurality of mobile devices, each mobile device associated with one of the workforce resources of the plurality of workforce resources; dynamically adapting the initial task assignments in real-time based on information received from the remote property management system or at least one or the plurality of mobile devices; and providing an indication of the dynamically updated task assignments to the remote property management system and at least one or the plurality of mobile devices.

Aspects of the above system include wherein generating the initial set of task assignments based on the information received from the remote property management systems comprises: assigning the sub-units of one or more sections to the initial set of task assignments for each of the workforce resources.

Aspects of the above system include wherein generating the initial set of task assignments based on the information received from the one or more of a plurality of property management systems further comprises: receiving, from the remote property management system, an indication of an initial status for each of the sub-units of each section; and providing an indication of the initial status for each sub-unit in the initial set of task assignments.

Aspects of the above system include wherein dynamically adapting the initial task assignments in real-time further comprises: receiving, from a first mobile device of the plurality of mobile devices an updated status for a sub-unit of one or the sections; and providing an indication of the updated status for the sub-unit of the one or more sections to the remote property management system and at least one second mobile device of the plurality of mobile device.

Aspects of the above system include wherein providing the indication of the updated status for the sub-unit of the one or more sections to the at least one second mobile device further comprises generating an updated set of task assignments for the workforce resource associated with each of the at least one second mobile device based on the received updated status and wherein the updated set of task assignments removes a task from the initial set of task assignments, changes a priority of task assignments in the initial set of task assignments, or indicates that a task assignment in the initial set of task assignments is now ready to be handled.

Aspects of the above system include wherein dynamically adapting the initial task assignments in real-time further comprises: receiving, from the remote property management system an updated status for a sub-unit of one or the sections; and providing an indication of the updated status for the sub-unit of the one or more sections to at least one device of the plurality of mobile device.

Aspects of the above system include wherein providing the indication of the updated status for the sub-unit of the one or more sections to the at least one mobile device further comprises generating an updated set of task assignments for the workforce resource associated with each of the at least one mobile device based on the received updated status and wherein the updated set of task assignments removes a task from the initial set of task assignments, changes a priority of task assignments in the initial set of task assignments, or indicates that a task assignment in the initial set of task assignments is now ready to be handled.

Embodiments include a non-transitory computer-readable medium comprising a set of instructions which, when executed by a processor, causes the processor to dynamically assign tasks by: generating an initial set of task assignments based on information received from a remote property management system, wherein the initial set of task assignments comprise assignment of a plurality of workforce resources to each of one or more sections of a property, each section comprising a plurality of sub-units and wherein the assignment of the workforce resources comprises overlapping assignment of two or more of the workforce resources to at least one or the one or more sections of the property; providing the generated initial set of task assignments to each of a plurality of mobile devices, each mobile device associated with one of the workforce resources of the plurality of workforce resources; dynamically adapting the initial task assignments in real-time based on information received from the remote property management system or at least one or the plurality of mobile devices; and providing an indication of the dynamically updated task assignments to the remote property management system and at least one or the plurality of mobile devices.

Aspects of the above non-transitory computer-readable medium include wherein generating the initial set of task assignments based on the information received from the remote property management systems comprises: assigning the sub-units of one or more sections to the initial set of task assignments for each of the workforce resources; receiving, from the remote property management system, an indication of an initial status for each of the sub-units of each section; and providing an indication of the initial status for each sub-unit in the initial set of task assignments.

Aspects of the above non-transitory computer-readable medium include wherein dynamically adapting the initial task assignments in real-time further comprises: receiving, from a first mobile device of the plurality of mobile devices an updated status for a sub-unit of one or the sections; and providing an indication of the updated status for the sub-unit of the one or more sections to the remote property management system and at least one second mobile device of the plurality of mobile device, wherein providing the indication of the updated status for the sub-unit of the one or more sections to the at least one second mobile device further comprises generating an updated set of task assignments for the workforce resource associated with each of the at least one second mobile device based on the received updated status and wherein the updated set of task assignments removes a task from the initial set of task assignments, changes a priority of task assignments in the initial set of task assignments, or indicates that a task assignment in the initial set of task assignments is now ready to be handled.

Aspects of the above non-transitory computer-readable medium include wherein dynamically adapting the initial task assignments in real-time further comprises: receiving, from the remote property management system an updated status for a sub-unit of one or the sections; and providing an indication of the updated status for the sub-unit of the one or more sections to at least one device of the plurality of mobile device, wherein providing the indication of the updated status for the sub-unit of the one or more sections to the at least one mobile device further comprises generating an updated set of task assignments for the workforce resource associated with each of the at least one mobile device based on the received updated status and wherein the updated set of task assignments removes a task from the initial set of task assignments, changes a priority of task assignments in the initial set of task assignments, or indicates that a task assignment in the initial set of task assignments is now ready to be handled.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating components of an exemplary system for dynamically assigning tasks according to one embodiment of the present disclosure.

FIG. 4 is a flowchart illustrating an exemplary process for dynamically assigning tasks according to one embodiment of the present disclosure.

FIG. 5 illustrates an exemplary control panel interface for defining sections of a property according to one embodiment of the present disclosure.

FIG. 6 illustrates an exemplary control panel interface for assigning sections according to one embodiment of the present disclosure.

FIGS. 7A-7C illustrate exemplary mobile device interfaces for presenting a dynamic assignment list according to one embodiment of the present disclosure.

FIG. 8 illustrates an exemplary mobile device interface for indicating a status change according to one embodiment of the present disclosure.

FIG. 9 illustrates an exemplary mobile device interface for indicating a status change according to another embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Embodiments of the disclosure provide systems and methods for dynamically adapting task assignments in real-time, or near-real time, based on information received from a remote property management system or at least one or a plurality of mobile devices. Utilizing current room status information, a dynamic list of rooms to service can be generated for each housekeeper and provided to each housekeeper through a mobile device. According to one embodiment, rooms can be assigned to multiple housekeepers. Additionally, room status can be update though the mobile devices. When room status information is updated, either by the property management system or through a mobile device, the task assignments can be dynamically updated. The first available housekeeper can then service rooms in a timelier and more efficient manner.

Stated another way, dynamically assigning tasks can comprise generating, by a resource management system, an initial set of task assignments based on information received from a remote property management system, wherein the initial set of task assignments comprise assignment of a plurality of workforce resources to each of one or more sections of a property, each section comprising a plurality of sub-units and wherein the assignment of the workforce resources comprises overlapping assignment of two or more of the workforce resources to at least one or the one or more sections of the property; providing, by the resource management system, the generated initial set of task assignments to each of a plurality of mobile devices, each mobile device associated with one of the workforce resources of the plurality of workforce resources; dynamically adapting, by the resource management system, the initial task assignments in real-time based on information received from the remote property management system or at least one or the plurality of mobile devices; and providing, by the resource management system, an indication of the dynamically updated task assignments to the remote property management system and at least one or the plurality of mobile devices.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

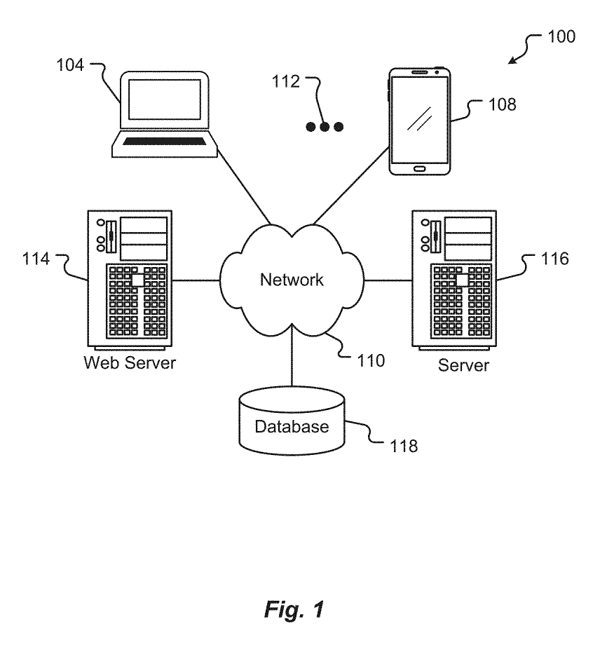

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation SIP, TCP/IP, SNA, IPX, AppleTalk, and the like. Merely by way of example, the network 110 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP (Session Initiation Protocol) servers, HTTP(s) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, PHP, JavaScript, or TCL, as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a storage-area network (“SAN”) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as MySQL, Postgres, Oracle 20i®, that is adapted to store, update, and retrieve data in response to SQL-formatted commands.

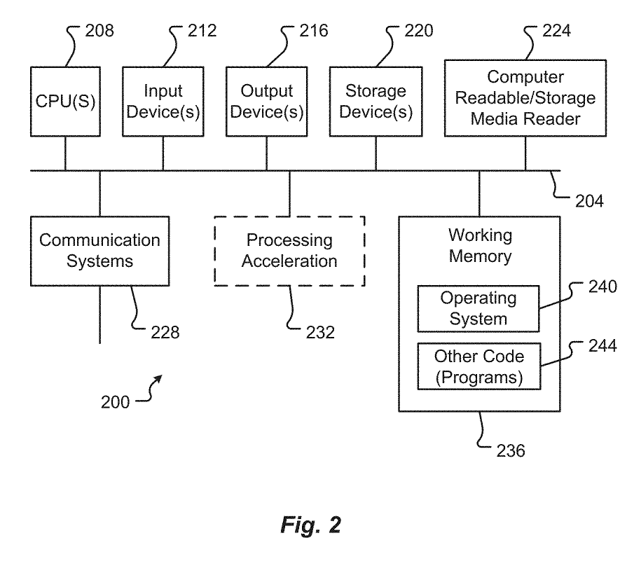

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more central processing units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a random-access memory (“RAM”) and/or a read-only memory (“ROM”), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a DSP, a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices, internet-based “cloud-storage”, and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used, and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

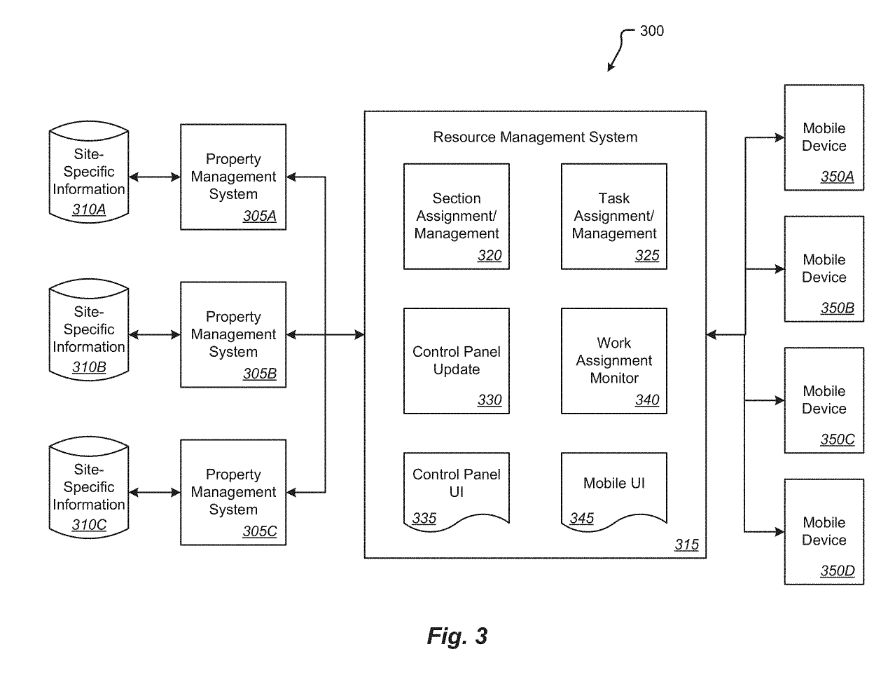

FIG. 3 is a block diagram illustrating components of an exemplary system for dynamically assigning tasks according to one embodiment of the present disclosure. As illustrated in this example, the system 300 can comprise any number of property management systems 305A-305C. The property management systems 305A-305C can each comprise one or more servers or other computing devices as described above. Generally speaking, and as known in the art, each property management system 305A-305C can comprise an on-site or cloud-based system executing applications for managing facilities, security, maintenance, etc., of a building or other property. For example, one or all of the property management systems 305A-305C can comprise systems and applications for managing a hotel, motel, lodge, bed & breakfast, or similar facility. It should be understood that, while three property management systems 305A-305C are illustrated here for exemplary purposes, any number of property management systems 305A-305C might be present in any particular implementation. Furthermore, it should be noted that, while reference is made here and throughout the disclosure to a hospitality implementation, i.e., wherein the property management systems 305A-305C are used to manage hotels, motels, lodges, etc., other implementations are possible in which various other types of facilities are being managed. Generally speaking and as will be described, embodiments are thought to be equally useful in other implementations in which it is desirable to dynamically manage task assignments made to mobile workforce resources such as housekeepers, maintenance staff, security personnel, and/or various automated/autonomous workforce resources.

Each property management system 305A-305C can maintain and utilize a set of site-specific information 310A-310C. As used herein, the term site-specific information refers to information related to and/or identifying conditions at the site being managed by the respective property management system 305A-305C. For example, in the hotel or hospitality implementation, the site-specific information 310A-310C can comprise information related to each room such as a status of the room being occupied or vacant etc. However, the site-specific information 310A-310C need not be stored local to the facility or even local to the property management system 305A-305C utilizing that information. Rather, the site-specific information 310A-310C can be stored in a cloud-based repository or some combination of local and cloud-based storage.

The system 300 can also include a resource management system 315. The resource management system 315 can comprise one or more servers or other computing devices as described above and can be communicatively coupled with each of the property management systems 305A-305C via a network (not shown here) as described above. Generally speaking, the resource management system 315 can execute one or more applications which, based on the site-specific information 310A-310C and/or data from the property management systems 305A-305C, can generate and dynamically adapt task assignments for a set of workforce resources. For example, in the hospitality implementation, the resource management system 315 can utilize current room status information obtained from the site-specific information 310A-310C through the property management systems 305A-305C to generate and update a dynamic list of rooms to service for each housekeeper. The lists can be provided to each housekeeper through a mobile device 350A-350D associated with that housekeeper over one or more communications networks (not shown here) as described above. When room status information is updated, either by a property management system 305A or through a mobile device 350A, the task assignments can be dynamically updated by the resource management system 315. According to one embodiment, rooms can be initially assigned to more than one housekeeper, i.e., room assignments between housekeepers can overlap. In this way, rooms can be serviced in a timelier manner and more efficiently as room status changes, e.g., guests check out, and as housekeepers become available throughout the normal course of the day.

More specifically, the resource management system 315 can comprise a section assignment and/or management module 320 and a task assignment and/or management module 325. Together, the section assignment and/or management module 320 and a task assignment and/or management module 325 can generate an initial set of task assignments based on site-specific information 310A received from a remote property management system 305A. The initial set of task assignments can comprise assignment of a plurality of workforce resources, e.g., housekeepers, to each of one or more sections of a property, e.g., floors, wings, buildings, etc. Each section can comprise a plurality of sub-units, e.g., rooms, and the assignment of the workforce resources can comprise overlapping assignment of two or more of the workforce resources to at least one or the one or more sections of the property.

To facilitate this initial assignment, the resource management system 315 can provide either a control panel user interface for users 335 or a software based Application Programming Interface (API) to the property management system 305A for use during set-up or initialization. The control panel user interface 335 can comprise a webpage or set of webpages or similar interfaces as will be described in greater detail below. Through this interface 335, a user of the property management system 305A can select sub-units, e.g. rooms, to be assigned to one or more sections such as rooms on each floor of the property. After this initial definition or set-up is complete, the resource management system 315 can begin making task assignments. To make task assignments, the resource management system 315 can receive from the remote property management system 305A, e.g., on a daily basis, an indication of an initial status for each of the sub-units of each section. This initial information can comprise, for example, an indication of whether the room is vacant or occupied, checked out, etc. Using this information, the task assignment and/or management module 325 of the resource management system 315 can generate an initial set of task assignments for the work force resources.

Once generated by the task assignment and/or management module 325, the initial set of task assignments can be provided by the resource management system 315 to each of the mobile devices 350A-350D associated with the workforce resources, e.g., the individual housekeepers' cell phones, tablets, etc. Accordingly, the resource management system 315 can provide a mobile user interface 345. The mobile user interface 345, as will be described in greater detail below, can comprise a webpage or set of webpages or a platform-native mobile application provided to and/or accessible by the mobile devices 350A-350D and through which the task assignment list, e.g., room list, for each workforce resource, e.g., housekeeper, can be viewed.

As noted above, the initial task assignments can be dynamically adapted and subsequently updated by the resource management system 315, in real-time or near real-time, based at least in-part on information received from the remote property management system 305A or at least one or the plurality of mobile devices 350A. For example, dynamically adapting the initial task assignments in real-time can comprise receiving, by a work assignment monitor module 340 of the resource management system 315 from a first mobile device 350A of the plurality of mobile devices 350A-350D an updated status for a sub-unit of one or the sections. In the hospitality implementation, for example, this can comprise a housekeeper indicated through the mobile user interface 345 on her mobile device 350A that she has started cleaning an assigned room, completed cleaning an assigned room, inspected an assigned room, indicating that a room has become vacant, i.e., that the guest has check out, etc. Based on this update, the task assignment and/or management module 325 can generate an updated set of task assignments for the workforce resource associated with another one or more mobile devices 350B-350D. That is, since task assignments may overlap, e.g., more than one housekeeper may be assigned a particular room, a particular assignment can be removed from or otherwise updated in a workforce resource's list once another workforce resource starts and/or completes that overlapping task.

Additionally, or alternatively, dynamically adapting the initial task assignments in real-time can comprise receiving, by a control panel update 330 module of the resource management system 315 from the remote property management system 315 an updated status for a sub-unit of one or the sections, e.g., an update to indicate that a guest has now checked out or vacated an assigned room. Based on this update, the task assignment and/or management module 325 can generate an updated set of task assignments for the assigned workforce resource(s). For example, in the hospitality implementation, a request may be made to have a room cleaned for early check-in. Accordingly, this room can be made a higher priority in the updated task assignments. Similarly, a room indicated as not in need or not desiring cleaning can be removed from the updated task assignments.

In either or both cases of updates from the mobile device(s) 350A-350D or the property management system 305A, an indication of the updated status for the sub-unit of the one or more sections can be provided by the resource management system 315 to the remote property management system 305A through the control panel user interface 335, e.g. when a housekeeper indicates start or completion of cleaning of a particular room, and/or at least one mobile device 350A of the plurality of mobile device 350A-350D, e.g., when the property management system 305A indicates that a room is now available for cleaning. As noted, the updated set of task assignments can remove a task from the initial set of task assignments, change a priority of task assignments in the initial set of task assignments, or indicate that a task assignment in the initial set of task assignments is now ready to be handled.

In use in the hospitality implementation, for example, hotel management can assign, through the control panel user interface 335, each housekeeper a pre-defined section of the hotel, which can include multiple rooms to be serviced and tasks to be performed, at the start of each day. Two or more housekeepers may be assigned the same or overlapping sections or rooms and tasks to be completed. For example, a ten-story hotel may have three housekeepers for the second-floor section, with a total of 30 rooms on that floor. These three housekeepers may be assigned the entire floor, rather than each housekeeper having ten individual rooms assigned to each. This significantly simplifies the task of room assignments from the perspective of the hotel management. Housekeepers can be presented through the mobile user interface 345 a dynamic prioritized list of all the rooms and tasks in their section. As each housekeeper begins to clean a room or start a task, which they can indicate through the mobile user interface, e.g., tapping a screen icon, clicking a button etc., the task assignment and/or management module 325 of the resource management system 315 can remove that room or task from all the other housekeepers dynamic list within the assigned section.

Dynamic lists presented to housekeepers via mobile devices 350A-350D in this way can allow for the same tasks to be presented to multiple housekeepers but serviced by one by dynamically removing tasks from housekeepers after another housekeeper has begun the task. The housekeepers' lists can be prioritized to present the highest priority available tasks at the top of the list and they are not presented tasks that have already been started or completed by other housekeepers. This approach provides better efficiency by eliminating time spent looking for an available task to complete. It can also improve guest satisfaction by getting early arriving guests into their rooms sooner by allowing more housekeepers to be able to service their room. It can also improve lead housekeeper's efficiency by having them spend less time adjusting task priorities and tracking down housekeepers.

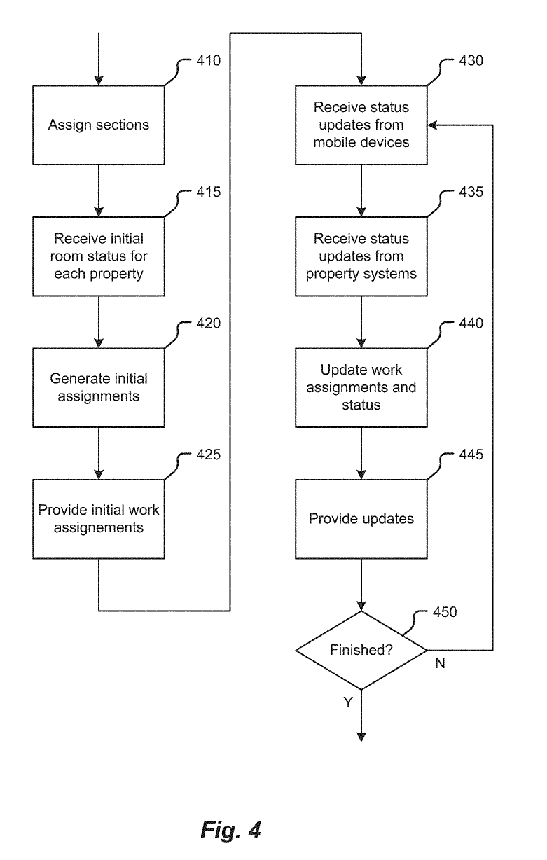

FIG. 4 is a flowchart illustrating an exemplary process for dynamically assigning tasks according to one embodiment of the present disclosure. As illustrated in this example, dynamically assigning tasks can comprise generating an initial set of task assignments based on information received from a remote property management system. More specifically, the resource management system can assign 410 the sub-units of each section to the initial set of task assignments for one or more of the workforce resources, e.g., based on rooms in each pre-defined section and the housekeepers or other staff assigned to those sections. In some cases, the resource management system may also receive 415 from the remote property management system, an indication of an initial status for each of the sub-units of each section. In such cases, an indication of the initial status for each sub-unit may be provided in the initial set of task assignments once generated as described below.

An initial set of task assignments can be generated 420 based on the information received from the remote property management system. The initial set of task assignments can comprise assignment of a plurality of workforce resources to each of one or more sections of a property. As noted, each section can comprise a plurality of sub-units and the assignment of the workforce resources can comprise overlapping assignment of two or more of the workforce resources to at least one or the one or more sections of the property. Once generated 420, the initial set of task assignments can be provided by the resource management system to each of the mobile devices associated with one of the workforce resources.

The initial task assignments can be dynamically adapted or updated by the resource management system, in real-time or near real-time, based on information received from the remote property management system or at least one or the plurality of mobile devices. For example, dynamically adapting the initial task assignments in real-time can comprise receiving 430, by the resource management system from a first mobile device of the plurality of mobile devices an updated status for a sub-unit of one or the sections and generating 440 an updated set of task assignments for the workforce resource associated with each of the at least one second mobile device based on the received updated status. Additionally, or alternatively, dynamically adapting the initial task assignments in real-time can comprise receiving 435, by the resource management system from the remote property management system an updated status for a sub-unit of one or the sections and generating 440 an updated set of task assignments for the workforce resource associated with each of the at least one mobile device based on the received updated status.

In either or both cases, an indication of the updated status for the sub-unit of the one or more sections can be provided 445 by the resource management system to the remote property management system and/or at least one second mobile device of the plurality of mobile device. For example, the updated set of task assignments can remove a task from the initial set of task assignments, change a priority of task assignments in the initial set of task assignments, or indicate that a task assignment in the initial set of task assignments is now ready to be handled. A determination 450 can then be made as to whether the tasks of the initial and/or updated task list have been completed. In response to determining 450 that the tasks have not all been completed, dynamically updating 430-445 the task list based on information received from the remote property management system or at least one or the plurality of mobile devices can continue until no tasks remain to be completed or until a determination 450 is made to otherwise end processing.

According to embodiments of the present disclosure, a number of different variations and additional details can be utilized depending upon the exact implementation. For example, the resource management system can provide and the mobile devices and remote property management systems described above can render or otherwise present user interfaces that can vary widely between implementations without departing from the scope of the present disclosure. Some exemplary user interfaces will be described below for illustrative purposes only. It should be understood that these examples are not intended to limit the scope of the present disclosure. Rather, they are offered by way of example only in an effort to give a more thorough understanding of some possible implementations of various embodiments described herein. It should be further understood that in different implementations these interfaces can differ in format and/or content without departing from the scope of the present disclosure.

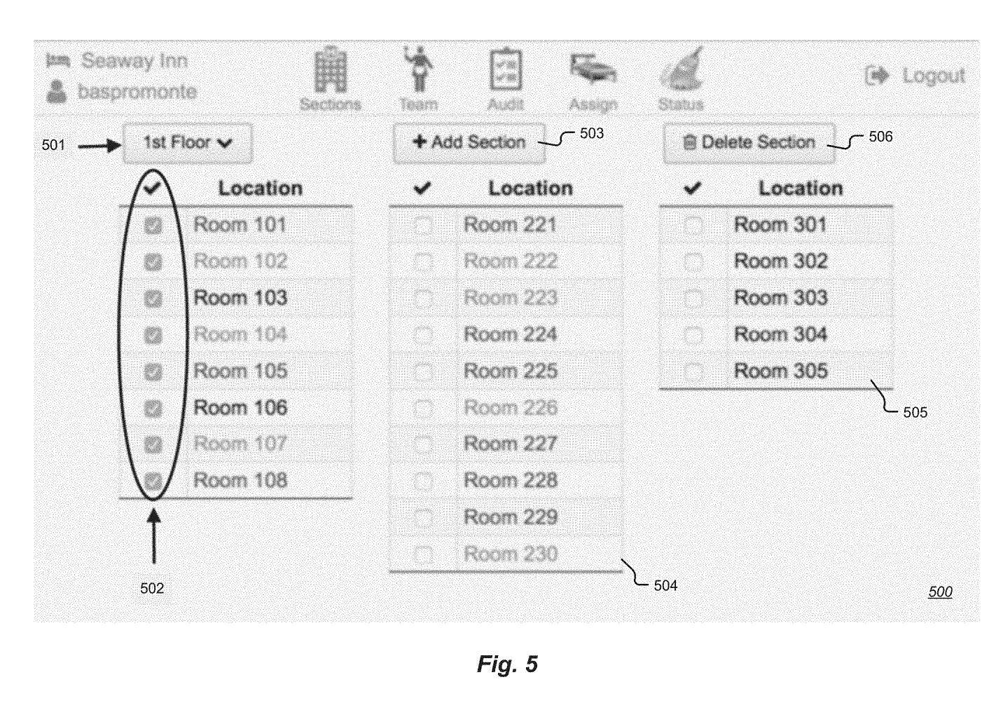

FIG. 5 illustrates an exemplary control panel interface for defining sections of a property according to one embodiment of the present disclosure. More specifically, this example illustrates a webpage 500 or similar interface, which can present a number of controls and other elements for defining sections in a property. As illustrated here, the webpage 500 can include a button 501 or icon for selecting a particular section or floor, e.g., from a dropdown list, and a set of check boxes 502 or similar elements for selecting sub-units or rooms. As shown here, the first floor section includes all rooms that need to be serviced on the first floor. Additional elements of the webpage can include but are not limited to a button 503 or icon for adding another section, an additional set of check boxes 504 and/or 505 for defining an additional section, if any, and to a button 506 or icon for deleting a defined section. Numerous variations in the format and/or content of the webpage are contemplated and considered to be within the scope of the present disclosure.

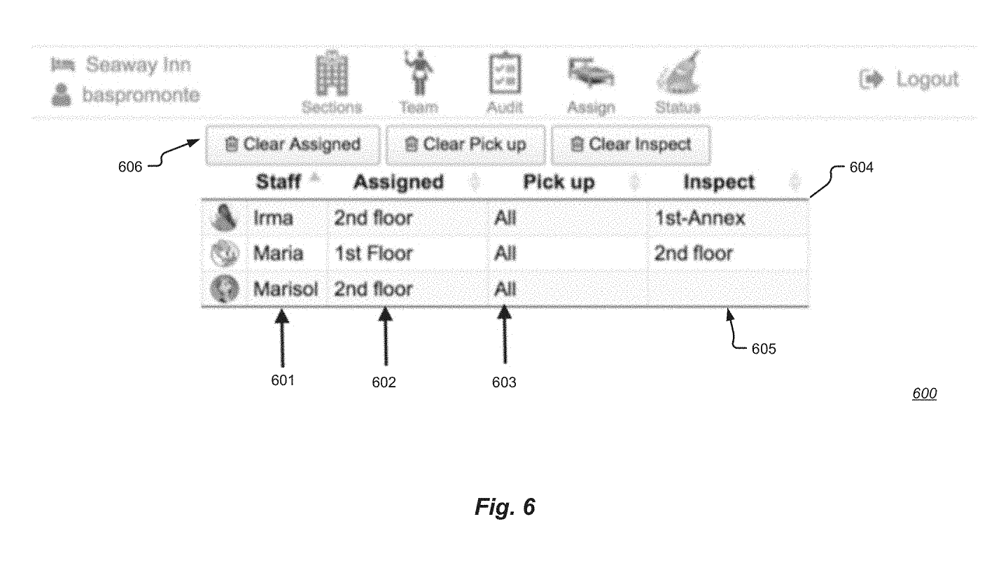

FIG. 6 illustrates an exemplary control panel interface for assigning sections according to one embodiment of the present disclosure. More specifically, this example illustrates a webpage 600 or similar interface which can present a number of controls and other elements for assigning tasks. As illustrated here, the webpage 600 can include a chart 604 through which staff, represented in the “Staff” column 601 can be assigned to tasks, e.g., via combo boxes, textboxes, dialog boxes, to other controls in or associated with the other columns 602, 603, and 605 of the chart 604. For example, a manager can assign staff to a section to be serviced in the Assigned column 602. Management can also assigns “Pick-up” tasks in column 603. Pick-up tasks are considered to be those tasks, which should be or could be performed once all assigned tasks have been completed by a particular staff person. As illustrated here, Irma is assigned the same section as Marisol and both staff members are assigned all tasks as their Pick-up section. In this example both are working off the same list of tasks, each starting a specific task as available. When one staff member starts a task, it is then no longer available on the other staff member's assigned task or pick up list. The chart 604 can also include an “Inspect” column 605 in which staff may be assigned sections to inspect and a set of controls 606 such as buttons or icons for clearing or resetting some or all of the columns 602, 603, and 605 of the chart 604. Numerous variations in the format and/or content of the webpage are contemplated and considered to be within the scope of the present disclosure.

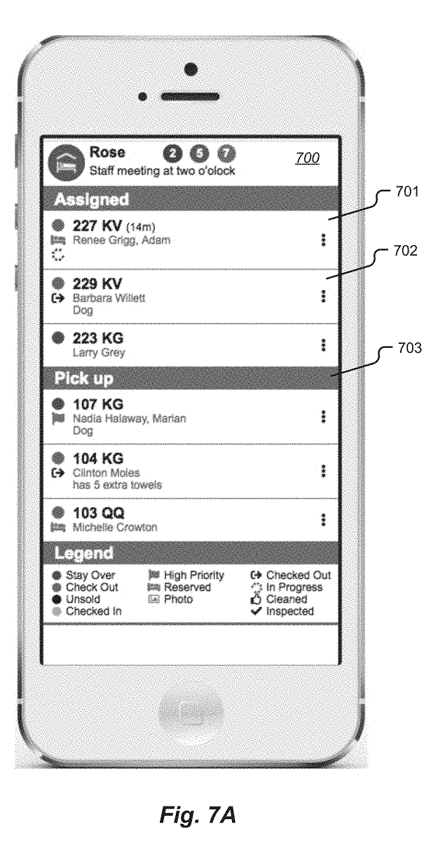

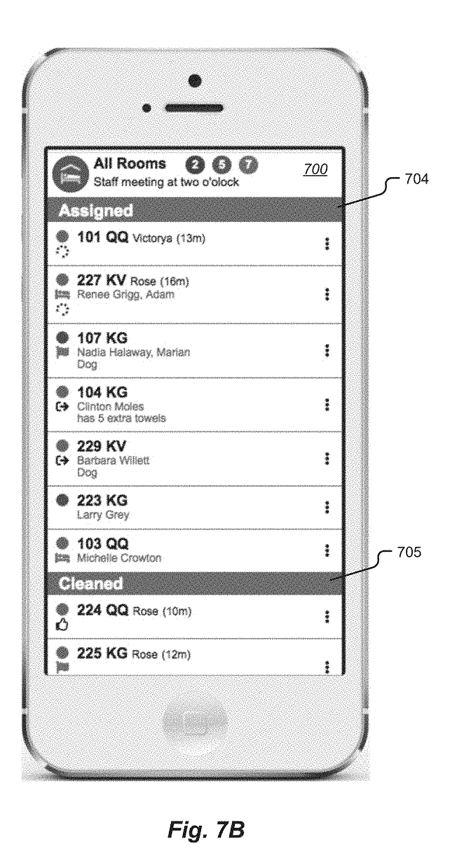

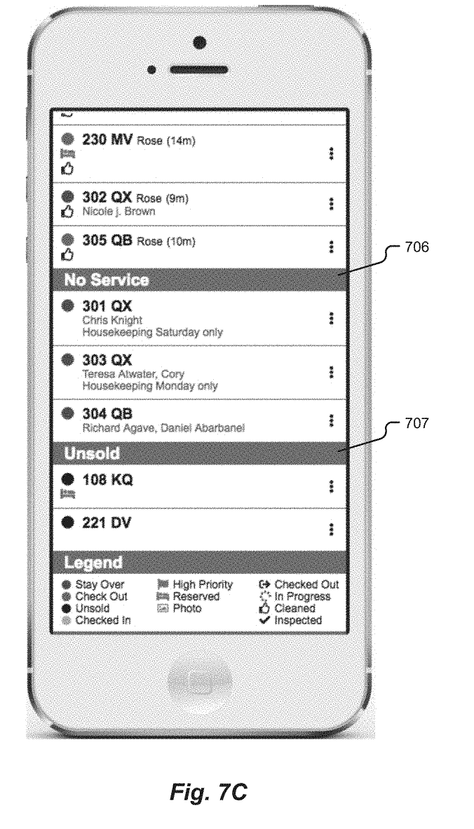

FIG. 7A illustrates an exemplary mobile device interface for presenting a dynamic assignment list according to one embodiment of the present disclosure. More specifically, this example illustrates a webpage 700 or similar interface which can present a dynamic list of assigned tasks. As illustrated here, the webpage 700 can include a dynamically assigned list of tasks 701, 702, 703. As shown here, the housekeeper is currently servicing task 701, i.e., room 227, and started the task 14 minutes ago. Room 227 is no longer available to any of the other staff members' list. Upon completion of the task and assuming no other staff starts the next task 702, i.e., room 229, the housekeeper will service that room next. This example also shows a list of her pick-up tasks 703. Both the assigned tasks 701 and 702 and pick-up tasks and 703 can be dynamically changed as tasks are completed by other housekeepers or the priority is changed by management.

FIG. 7B illustrates the same webpage 700 updated to present an “All Rooms” view which shows a list 704 of all assigned rooms and a list 705 of all rooms cleaned so far. Scrolling down on this interface, as illustrated by FIG. 7C, additional information an be presented including a list 706 rooms occupied but not requiring service and so unassigned as well as a list 707 of rooms that are unsold and not requiring cleaning and therefore also unassigned. Numerous variations in the format and/or content of the webpage are contemplated and considered to be within the scope of the present disclosure.

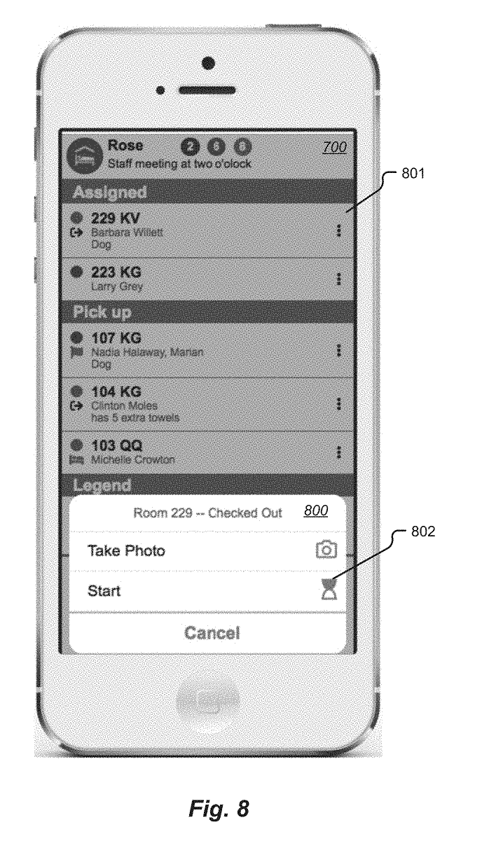

FIG. 8 illustrates an exemplary mobile device interface for indicating a status change according to one embodiment of the present disclosure. More specifically, this example illustrates a webpage 700 or similar interface which can present a list of tasks as described above and through which updated status for a selected task can be indicated. As illustrated here, the housekeeper can select a task 801 from the list, e.g., by tapping, clicking, or otherwise manipulating the user interface. In response, a dialog box 800 can be opened. Through this box, the housekeeper can touch, click, or otherwise select an icon 802 or other control to indicate that the task has been started. As described, this task can then be removed from other staffs' lists. Numerous variations in the format and/or content of the webpage are contemplated and considered to be within the scope of the present disclosure.

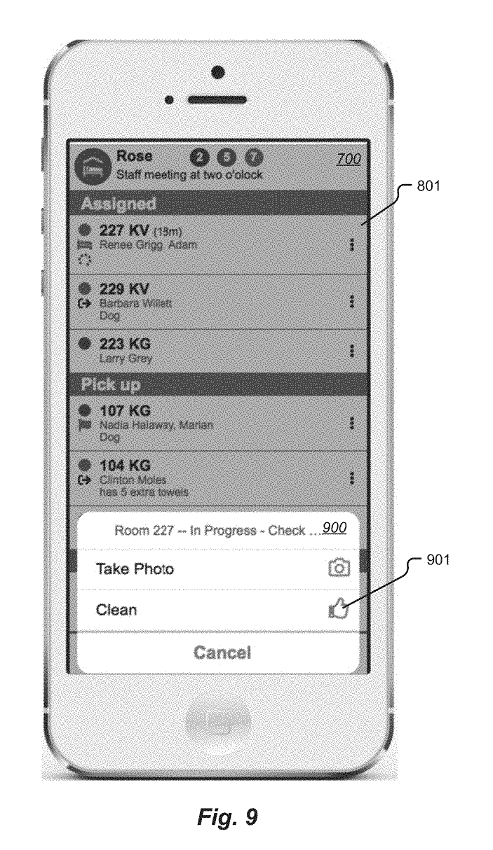

FIG. 9 illustrates an exemplary mobile device interface for indicating a status change according to another embodiment of the present disclosure. More specifically, this example illustrates the webpage 700 described above for presenting a list of assigned tasks. As described, a task 801 can be selected when started. Here, the dialog box 900 has been updated to present an icon 901 or other control which the housekeeper can touch, click, or otherwise select once finished to indicate that the task has been completed. The task can then be added to the completed task list as described above. Numerous variations in the format and/or content of the webpage are contemplated and considered to be within the scope of the present disclosure.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for dynamically assigning tasks, the method comprising:
generating, by a resource management system, an initial set of task assignments based on information received from a remote property management system, wherein the initial set of task assignments comprise assignment of a plurality of workforce resources to each of one or more sections of a property, each section comprising a plurality of sub-units and wherein the assignment of the workforce resources comprises overlapping assignment of two or more of the workforce resources to at least one or the one or more sections of the property;
providing, by the resource management system, the generated initial set of task assignments to each of a plurality of mobile devices, each mobile device associated with one of the workforce resources of the plurality of workforce resources;
dynamically adapting, by the resource management system, the initial task assignments in real-time based on information received from the remote property management system or at least one or the plurality of mobile devices; and
providing, by the resource management system, an indication of the dynamically updated task assignments to the remote property management system and at least one or the plurality of mobile devices.

2. The method of claim 1, wherein generating the initial set of task assignments based on the information received from the remote property management systems comprises:
assigning, by the resource management system, the sub-units of one or more sections to the initial set of task assignments for each of the workforce resources.

3. The method of claim 2, wherein generating the initial set of task assignments based on the information received from the one or more of a plurality of property management systems further comprises:
receiving, by the resource management system from the remote property management system, an indication of an initial status for each of the sub-units of each section; and
providing, by the resource management system, an indication of the initial status for each sub-unit in the initial set of task assignments.

4. The method of claim 1, wherein dynamically adapting the initial task assignments in real-time further comprises:
receiving, by the resource management system from a first mobile device of the plurality of mobile devices an updated status for a sub-unit of one or the sections; and
providing, by the resource management system, an indication of the updated status for the sub-unit of the one or more sections to the remote property management system and at least one second mobile device of the plurality of mobile device.

5. The method of claim 4, wherein providing the indication of the updated status for the sub-unit of the one or more sections to the at least one second mobile device further comprises generating an updated set of task assignments for the workforce resource associated with each of the at least one second mobile device based on the received updated status.

6. The method of claim 5, wherein the updated set of task assignments removes a task from the initial set of task assignments, changes a priority of task assignments in the initial set of task assignments, or indicates that a task assignment in the initial set of task assignments is now ready to be handled.

7. The method of claim 1, wherein dynamically adapting the initial task assignments in real-time further comprises:
receiving, by the resource management system from the remote property management system an updated status for a sub-unit of one or the sections; and
providing, by the resource management system, an indication of the updated status for the sub-unit of the one or more sections to at least one device of the plurality of mobile device.

8. The method of claim 7, wherein providing the indication of the updated status for the sub-unit of the one or more sections to the at least one mobile device further comprises generating an updated set of task assignments for the workforce resource associated with each of the at least one mobile device based on the received updated status.

9. The method of claim 8, wherein the updated set of task assignments removes a task from the initial set of task assignments, changes a priority of task assignments in the initial set of task assignments, or indicates that a task assignment in the initial set of task assignments is now ready to be handled.

10. A system comprising:
a processor; and
a memory coupled with and readable by the processor and storing therein a set of instructions which, when executed by the processor, causes the processor to dynamically assign tasks by:
generating an initial set of task assignments based on information received from a remote property management system, wherein the initial set of task assignments comprise assignment of a plurality of workforce resources to each of one or more sections of a property, each section comprising a plurality of sub-units and wherein the assignment of the workforce resources comprises overlapping assignment of two or more of the workforce resources to at least one or more sections of the property;
providing the generated initial set of task assignments to each of a plurality of mobile devices, each mobile device associated with one of the workforce resources of the plurality of workforce resources;
dynamically adapting the initial task assignments in real-time based on information received from the remote property management system or at least one or the plurality of mobile devices; and
providing an indication of the dynamically updated task assignments to the remote property management system and at least one or the plurality of mobile devices.

11. The system of claim 10, wherein generating the initial set of task assignments based on the information received from the remote property management systems comprises:
assigning the sub-units of one or more sections to the initial set of task assignments for each of the workforce resources.

12. The system of claim 11, wherein generating the initial set of task assignments based on the information received from the one or more of a plurality of property management systems further comprises:
receiving, from the remote property management system, an indication of an initial status for each of the sub-units of each section; and
providing an indication of the initial status for each sub-unit in the initial set of task assignments.

13. The system of claim 10, wherein dynamically adapting the initial task assignments in real-time further comprises:
receiving, from a first mobile device of the plurality of mobile devices an updated status for a sub-unit of one or the sections; and
providing an indication of the updated status for the sub-unit of the one or more sections to the remote property management system and at least one second mobile device of the plurality of mobile device.

14. The system of claim 13, wherein providing the indication of the updated status for the sub-unit of the one or more sections to the at least one second mobile device further comprises generating an updated set of task assignments for at least one workforce resource based on the received updated status and wherein the updated set of task assignments removes a task from the initial set of task assignments, changes a priority of task assignments in the initial set of task assignments, or indicates that a task assignment in the initial set of task assignments is now ready to be handled.

15. The system of claim 10, wherein dynamically adapting the initial task assignments in real-time further comprises:
receiving, from the remote property management system an updated status for a sub-unit of one or the sections; and
providing an indication of the updated status for the sub-unit of the one or more sections to at least one device of the plurality of mobile device.

16. The system of claim 15, wherein providing the indication of the updated status for the sub-unit of the one or more sections to the at least one mobile device further comprises generating an updated set of task assignments for the workforce resource associated with each of the at least one mobile device based on the received updated status and wherein the updated set of task assignments removes a task from the initial set of task assignments, changes a priority of task assignments in the initial set of task assignments, or indicates that a task assignment in the initial set of task assignments is now ready to be handled.

17. A non-transitory computer-readable medium comprising a set of instructions which, when executed by a processor, causes the processor to dynamically assign tasks by:
generating an initial set of task assignments based on information received from a remote property management system, wherein the initial set of task assignments comprise assignment of a plurality of workforce resources to each of one or more sections of a property, each section comprising a plurality of sub-units and wherein the assignment of the workforce resources comprises overlapping assignment of two or more of the workforce resources to at least one or the one or more sections of the property;
providing the generated initial set of task assignments to each of a plurality of mobile devices, each mobile device associated with one of the workforce resources of the plurality of workforce resources;
dynamically adapting the initial task assignments in real-time based on information received from the remote property management system or at least one or the plurality of mobile devices; and
providing an indication of the dynamically updated task assignments to the remote property management system and at least one or the plurality of mobile devices.

18. The non-transitory computer-readable medium of claim 17, wherein generating the initial set of task assignments based on the information received from the remote property management systems comprises:
assigning the sub-units of one or more sections to the initial set of task assignments for each of the workforce resources;
receiving, from the remote property management system, an indication of an initial status for each of the sub-units of each section; and
providing an indication of the initial status for each sub-unit in the initial set of task assignments.

19. The non-transitory computer-readable medium of claim 17, wherein dynamically adapting the initial task assignments in real-time further comprises:
receiving, from a first mobile device of the plurality of mobile devices an updated status for a sub-unit of one or the sections; and
providing an indication of the updated status for the sub-unit of the one or more sections to the remote property management system and at least one second mobile device of the plurality of mobile device, wherein providing the indication of the updated status for the sub-unit of the one or more sections to the at least one second mobile device further comprises generating an updated set of task assignments for at least one workforce resource based on the received updated status and wherein the updated set of task assignments removes a task from the initial set of task assignments, changes a priority of task assignments in the initial set of task assignments, or indicates that a task assignment in the initial set of task assignments is now ready to be handled.

20. The non-transitory computer-readable medium of claim 17, wherein dynamically adapting the initial task assignments in real-time further comprises:
receiving, from the remote property management system an updated status for a sub-unit of one or the sections; and
providing an indication of the updated status for the sub-unit of the one or more sections to at least one device of the plurality of mobile device, wherein providing the indication of the updated status for the sub-unit of the one or more sections to the at least one mobile device further comprises generating an updated set of task assignments for the workforce resource associated with each of the at least one mobile device based on the received updated status and wherein the updated set of task assignments removes a task from the initial set of task assignments, changes a priority of task assignments in the initial set of task assignments, or indicates that a task assignment in the initial set of task assignments is now ready to be handled.
